(19) United States
(12) Patent Application Publication
(10) Pub. No.: US 2024/0062508 A1
(43) Pub. Date: Feb. 22, 2024

(54) Monochrome and Color Images Fusion for Artificial Reality Systems

(71) Applicant: Meta Platforms Technologies, LLC, Menlo Park, CA (US)

(72) Inventors: Anatoly Litvinov, Binyamina (IL); Andrey Tovchigrechko, Saratoga, CA (US); Sebastian Sztuk, Virum (DK); Ilya Brailovskiy, Fremont, CA (US)

(21) Appl. No.: 18/452,445

(22) Filed: Aug. 18, 2023

Related U.S. Application Data
(60) Provisional application No. 63/398,973, filed on Aug. 18, 2022.

(51) Int. Cl. G06V 10/56; H04N 5/14; G06T 5/00; G06T 5/40; G06V 10/60

(52) U.S. Cl. CPC G06V 10/56; H04N 5/145; G06T 5/002; G06T 5/009; G06T 5/40; G06V 10/60; G06T 2207/10024; G06T 2207/20016

(57) ABSTRACT

In particular embodiments, a computing system may receive a color image captured by a color camera and a monochrome image captured by a monochrome camera. The color camera and the monochrome camera are associated with an artificial reality system. The computing system may compute, for each of the color and monochrome images, histogram statistics and perform, based on the histogram statistics, tone map matching to normalize the monochrome image with respect to the color image. The computing system may perform local motion estimation to calculate motion vectors indicating pixel correspondence between the normalized monochrome image and the color image. The computing system may generate a mono-color merged image for display on the artificial reality system by adding, for each pixel in the normalized monochrome image, color information extracted from corresponding pixel in the color image using the motion vectors.

### PRIORITY

This application claims the benefit, under 35 U.S.C. § 119(e), of U.S. Provisional Patent Application No. 63/398,973, filed 18 Aug. 2022, which is incorporated herein by reference.

### TECHNICAL FIELD

This disclosure generally relates to computer graphics and 3D reconstruction techniques.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality. Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers.

“Passthrough” is a feature that allows a user to see their physical surroundings while wearing an artificial reality system, such as, for example, a mixed reality (MR) headset. Information about the user's physical environment is visually “passed through” to the user by having the MR headset display information captured by the headset's external-facing cameras. Generally, the conventional artificial reality systems (e.g., mixed reality headsets) include color cameras (e.g., red, green, and blue (RGB) camera sensors) to capture the surrounding environment of the user and provide a color passthrough image of the surrounding environment to the user. These color or RGB cameras associated with the artificial reality systems may not deliver optimal camera performance in all situations and/or environments, especially in poorly lit environments or environments with poor lighting conditions (e.g., low light conditions ranging between 20-200 lux or ultra-low light conditions (<20 lux)). This is due to a variety of physical, design, and/or power constraints imposed by the artificial reality system, and also due to color camera's poor sensitivity to low light conditions. The color images captured by the color cameras in low light conditions generally contains noise, such as low frequency chroma noise, color noise, etc.

A monochrome camera or sensor comprised within the monochrome camera, on the other hand, has a much better and/or improved sensitivity (e.g., approximately 3-4 times better sensitivity than the RGB camera). Due to this improved sensitivity, the monochrome camera works well in the poorly lit environments or environments with poor lighting conditions (e.g., low-light and ultra-low light conditions). However, for a color passthrough image, a color/RGB camera is also required in addition to the monochrome camera. Accordingly, there is a need for an improved artificial reality system that can make use of both color and monochrome cameras to generate a high-quality and noise-free color passthrough image, especially in low-light conditions or environments.

### SUMMARY OF PARTICULAR EMBODIMENTS

Particular embodiments described herein relates to an improved artificial reality system (e.g., mixed reality system) that makes use of a monochrome camera along with a color camera and a mono-color fusion technique that merges outputs from these two cameras to produce better low light images. The mono-color fusion technique discussed herein combines results from the monochrome and color cameras to reconstruct a high-resolution color passthrough image with noise reduced, as compared to a noisy low-resolution color passthrough image produced with only having the color cameras on the artificial reality system.

In particular embodiments, a method or process for fusing monochrome and color images to generate a mono-color merged image may begin in response to determining that lighting conditions associated with an artificial reality system (e.g., mixed reality system) fall within a certain luminance range. By way of an example and without limitation, the fusing process may be performed when the light level in which the artificial reality system is operating is low light conditions or within 20-200 lux range. It should be noted that the fusion process and the monochrome cameras discussed herein may not be used and only color images captured through color cameras of the artificial reality system will be used to generate an image for display when the artificial reality system is operating in a well-lit environment, such as lighting conditions above 200 lux. Upon initiating the fusion process, a computing unit of the improved artificial reality system discussed herein may receive a color image captured by a color camera and a monochrome image captured by a monochrome camera. The color and monochrome images may be synchronously captured by the color and monochrome cameras, respectively, at similar times. The color camera and the monochrome camera may be associated with an artificial reality system. For instance, the color and monochrome cameras may be mounted next to each other on the artificial reality system. Responsive to receiving the color and monochrome images from the color and monochrome cameras, respectively, the computing unit may compute histogram statistics for each of the color and monochrome images. Based on the histogram statistics, tone map matching (or dynamic block matching) is performed to normalize the monochrome image with respect to the color image. The computing unit then performs gaussian pyramid decomposition to transform normalized monochrome image into a first pyramid of images and the color image into a second pyramid of images. Local motion estimation may be performed to calculate motion vectors based on the first pyramid of images corresponding to the normalized monochrome image and the second pyramid of images corresponding to the color image. The motion vectors may indicate pixel correspondence between the normalized monochrome image and the color image. For instance, the motion vectors may be a matrix or grid-like structure indicating for each monochrome pixel, where it is located or reside within the RGB image. A mono-color merged image is generated for display on the artificial reality system by adding, for each pixel in the normalized monochrome image, color information extracted from corresponding pixel in the color image using the motion vectors. Stated differently, color information is extracted from RGB pixels corresponding to the monochrome pixels using the motion vectors (e.g., pixel correspondence) and adding the extracted color information to the monochrome pixels. For instance, extracted color information may be added to Y channel extracted from the monochrome image.

In particular embodiments, the resulting mono-color merged image that is generated using the mono-color fusion process discussed above may include some noise, such as luma and color noise. In order to improve the quality of the merged image and remove noise (e.g., luma and color noise, low frequency chroma noise), post processing functions or treatments may be required. For instance, the computing unit of the improved artificial reality system may further perform a de-noising process to remove one or more noise artifacts (e.g., luma noise from the monochrome camera, color noise from the color camera, low frequency chroma noise from the color camera, etc.) from the mono-color merged image, generate a de-noised mono-color merged image by applying one or more post processing functions, and then display the de-noised mono-color merged image as a passthrough image on a display of the artificial reality system. In particular embodiments, the one or more post processing functions may include temporal noise reduction and spatial noise reduction. In some embodiments, the monochrome and color cameras discussed herein may have different capture resolutions, and images produced from these cameras of different capture resolutions may be merged to produce a final passthrough image and present to a user.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example configuration of an improved artificial reality system discussed herein.

FIG. 2A illustrates an example mono-color fusion process or flow for merging a monochrome image and a color image to generate a mono-color merged image for an artificial reality system.

FIG. 2B illustrates an example de-noising process to generate a de-noised mono-color merged image for an artificial reality system.

FIG. 3 illustrates a high-level diagram for fusion of monochrome and color images.

FIG. 4 illustrates another example data-flow diagram for fusion of monochrome and color images.

FIG. 5 illustrates an example comparison between an image that is generated only with color cameras, an image that is generated only with monochrome cameras, and a mono-color merged image that is generated based on the mono-color fusion process and the de-noising process discussed herein.

FIG. 6 illustrates an example method for fusing a monochrome image and a color image to generate a mono-color merged image for display on an artificial reality system, in accordance with particular embodiments.

FIG. 7 illustrates an example of an artificial reality system worn by a user.

FIG. 8 illustrates an example network environment associated with an artificial reality system.

FIG. 9 illustrates an example computer system.

### DESCRIPTION OF EXAMPLE EMBODIMENTS

“Passthrough” is a feature that allows a user to see their physical surroundings while wearing an artificial reality system, such as, for example, a mixed reality (MR) headset. Information about the user's physical environment is visually “passed through” to the user by having the MR headset display information captured by the headset's external-facing cameras. By way of an example and without limitation, if a first user wearing the headset is enjoying a movie and a second user comes in and requires attention of the first user, then the external cameras of the headset may provide a passthrough image of the second user and their surrounding environment to the first user wearing the headset. Generating and displaying a passthrough image in an artificial reality system is discussed in U.S. patent application Ser. No. 16/746,128, filed 17 Jan. 2020, now U.S. Pat. No. 11,410,387, and U.S. patent application Ser. No. 16/773,770, filed 27 Jan. 2020, now U.S. Pat. No. 11,113,891, each of which is hereby incorporated by reference in its entirety.

Generally, the conventional artificial reality systems (e.g., mixed reality headsets) include color cameras (e.g., red, green, and blue (RGB) camera sensors) to capture the surrounding environment of the user and provide a color passthrough image of the surrounding environment to the user. These color or RGB cameras associated with the artificial reality systems (e.g., MR headsets) may not deliver optimal camera performance in all situations and/or environments. For instance, the artificial reality systems may have a variety of physical, design, and/or power constraints due to which image sensors or camera sensors that are typically associated with these artificial reality systems are relatively small in size than the ones associated with regular computing devices (e.g., DSLR cameras, high-end mobile devices, etc.). These small-sized RGB sensors may work well in bright lighting conditions, such as, for example, when the user is outside in a bright sunny day or wearing the artificial reality system in a well-lit room. However, these small-sized RGB sensors may not deliver good camera performance in poorly lit environments or environment with low lighting conditions, such as, for example, at nighttime when the user is watching a movie wearing the headset. This is because the sensitivity of the RGB color sensor towards low light is considerably low as there is not enough light to enter in.

A monochrome camera or sensor associated with the monochrome camera, on the other hand, has a much better and/or improved sensitivity (e.g., approximately 3-4 times better sensitivity than the RGB camera). Due to this improved sensitivity, the monochrome camera works very well in environments with poor lighting conditions (e.g., low-light conditions). The monochrome camera is configured to generate an image with a single color or hue. For example, the monochrome camera may produce a visual image in a single color or in varying tones of a single color, such as gray. However, since the artificial reality system (e.g., MR headset) needs to generate a color passthrough image, an RGB camera is also required in addition to the monochrome camera. Accordingly, there is a need for an improved artificial reality system (e.g., improved mixed reality headset) that includes both the monochrome and RGB cameras and a technique for fusing the images from these two cameras in order to generate high quality continuous stream of camera data (e.g., passthrough images or videos), especially in low-light conditions or environments.

Particular embodiments described herein relates to an improved artificial reality system (e.g., mixed reality system) that makes use of a monochrome camera (or a monochrome sensor associated with the monochrome camera) along with a RGB camera (or color/RGB sensor associated with the RGB camera) and a mono-RGB fusion technique that merges outputs from these two cameras to produce better low light images. The sensitivity of the monochrome camera for a particular pixel is almost 3 times better than the sensitivity of the RGB pixel, because RGB pixel is only letting one light waveform through the lens, whereas monochrome camera is letting pretty much all the light that will be in the visible spectrum that gives significantly better signal and stronger information. The mono-RGB fusion technique discussed herein combines results from the two cameras to reconstruct a high-resolution color passthrough image with noise reduced, as compared to a noisy low-resolution color passthrough image produced with only having the high-resolution RGB camera.

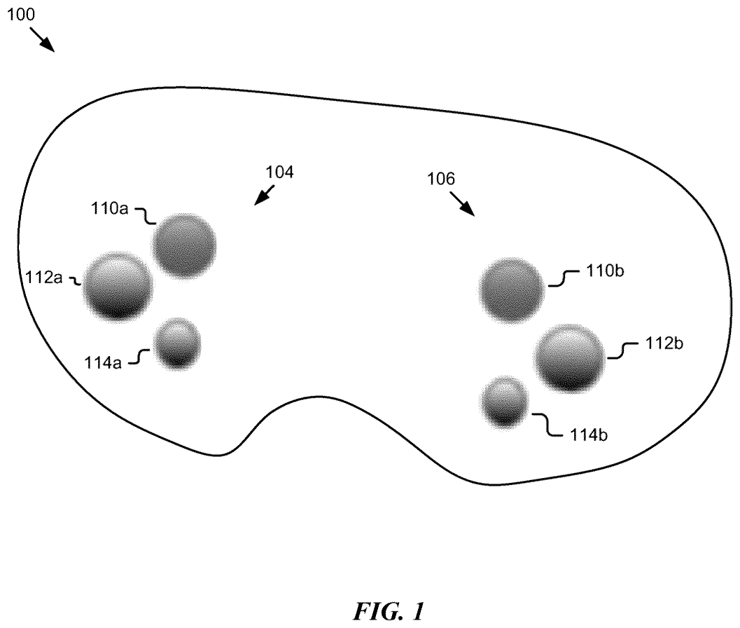

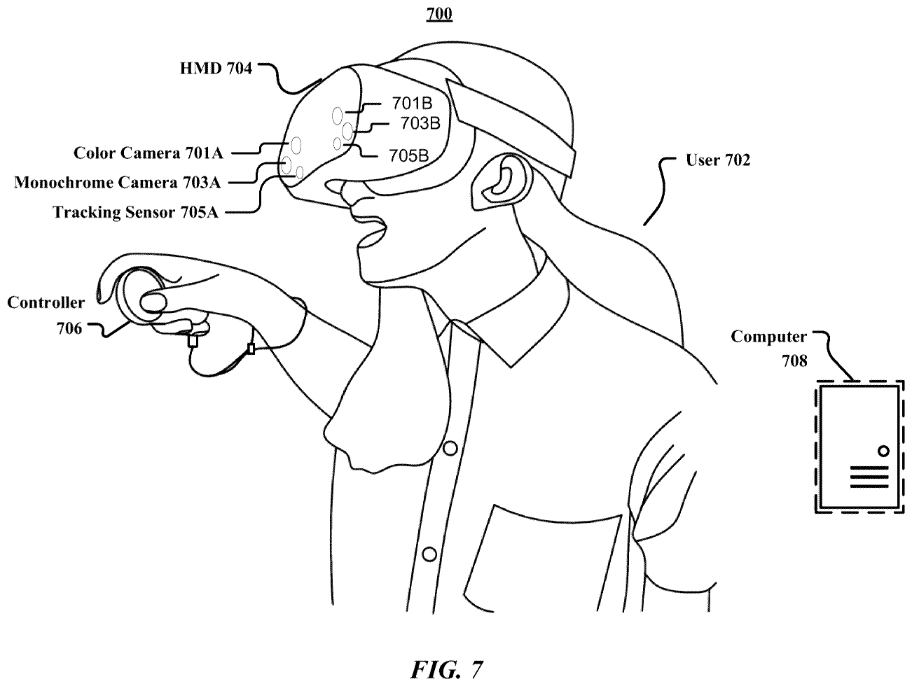

FIG. 1 illustrates an example configuration 100 of an improved artificial reality system discussed herein. In particular embodiments, the improved artificial reality system discussed herein is a mixed reality headset. One such mixed reality headset and/or improved artificial reality system is shown in FIG. 7. The example configuration 100 is designed to provide maximum flexibility for software-based selection of camera configuration and mitigate software-resourcing risks. Additionally, the example configuration 100 discussed herein is designed to deliver optimal and good camera performance at different lighting conditions, including low-light conditions (e.g., less than 20 lux), medium-light or low-light conditions (e.g., 20-200 lux), and bright-light conditions (e.g., greater than 200 lux). As depicted, the improved artificial reality system discussed herein includes two cameras and one or more sensors at each side of the system. These include a color/RGB camera, a monochrome camera, and a tracking sensor. Specifically, the left side 104 of the headset includes a RGB camera 110a (or a color/RGB sensor associated with the RGB camera 110a), a monochrome camera 112a (or a monochrome sensor associated with the monochrome camera 112a), and a tracking sensor 114a. Similarly, the right side 106 of the headset includes a RGB camera 110b (or a color/RGB sensor associated with the RGB camera 110b), a monochrome camera 112b (or a monochrome sensor associated with the monochrome camera 112b), and a tracking sensor 114b. The RGB cameras 110a and 110b (also individual and/or collectively herein referred to as 110) are configured to capture and generate color passthrough images. The monochrome cameras 112a and 112b (also individual and/or collectively herein referred to as 112) are configured to capture and generate monochrome passthrough images. The tracking sensors 114a and 114b (also individual and/or collectively herein referred to as 114) are configured to be used for tracking purposes, such as, for example, hand tracking, eye tracking, body tracking, etc.

In some embodiments, both the RGB cameras 110 and monochrome cameras 112 are high-resolution cameras. As an example and not by way of limitation, both the RGB cameras 110 and monochrome cameras 112 may be 16 megapixel (MP) cameras that supports up to 8K recording. As another example, the RGB cameras 110 may be 4 MP cameras, whereas the monochrome cameras 112 may be 16 MP cameras. Other variations and/or combinations of RGB and monochrome cameras are possible and within the scope of the present disclosure. In particular embodiments, depending on the current light level in the user's environment, different combinations of cameras 110, 112 may be used. The following table shows one example embodiment of a control flow:

| Light Level | Control Scenario |
|---|---|
| Bright light (>200 lux) | Use only the RGB camera |
| Low light (20-200 lux) | 1. Start with the RGB camera only, and |
| | 2. Transition to RGB/Monochrome |
| | fusion solution based on the tunable |
| | threshold. |
| Ultra-low light (<20 lux) | Use only the monochrome camera (no |
| | color images). This is because humans |
| | do not really see color at very low lights |
| | anyway so using color camera does not |
| | make a difference and the user's |
| | experience is therefore not impacted. |

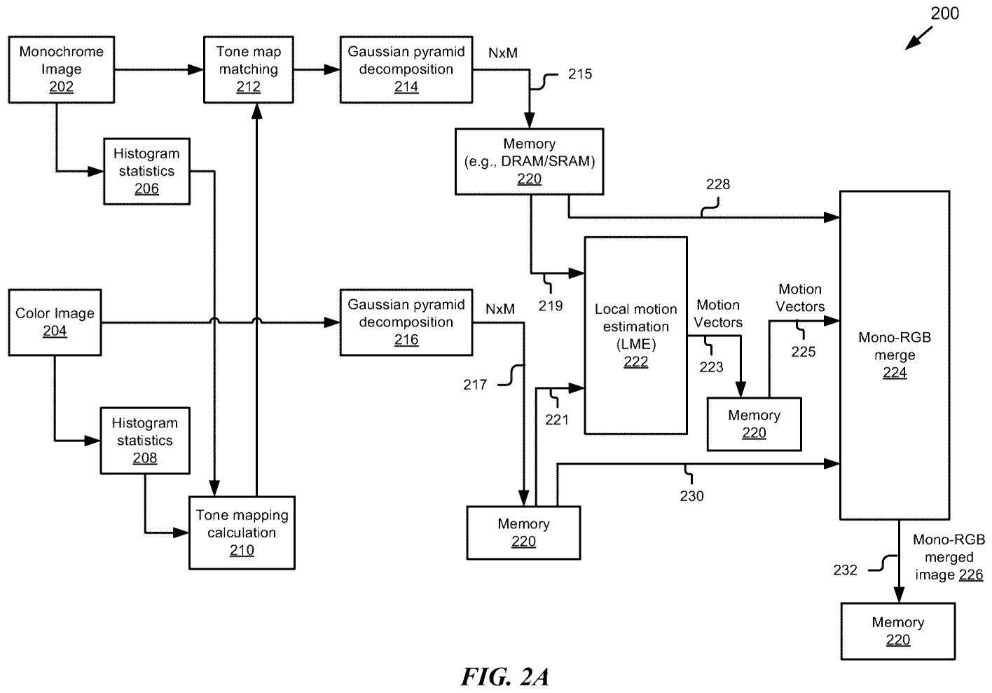

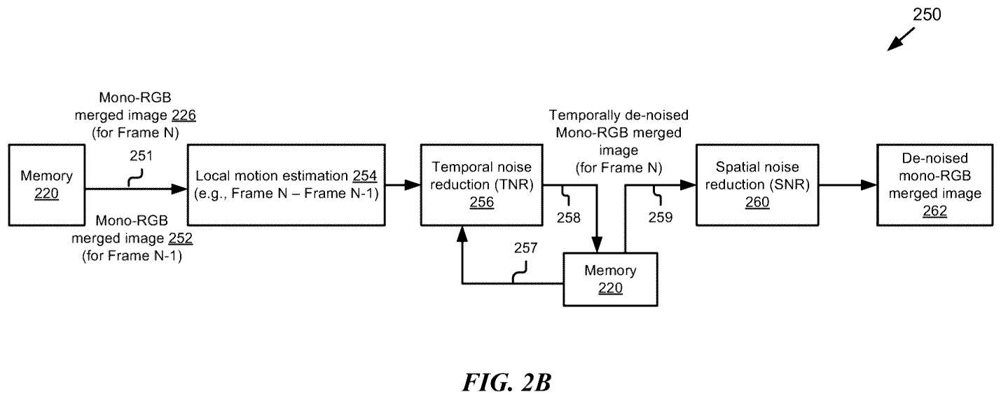

In particular embodiments, the RGB cameras 110 and monochrome cameras 112 may be combined to deliver the color passthrough experience at different lighting conditions. The main idea is to use high quality images that could be captured in medium and low light conditions by a monochrome camera 112, and add color information from RGB camera 110 to provide good quality color image or video. A detailed mono-RGB fusion process, algorithm, and/or pipeline to generate a color passthrough image is discussed in reference to at least FIGS. 2A-2B. In particular embodiments, for the mono-RGB fusion to work, a number of assumptions have been made. These assumptions include, for example and without limitation, that (1) RGB and mono cameras (or sensors associated with these cameras) are co-located near each other, (2) monochrome cameras 112 have equal or higher resolution compared to color cameras 110, (3) RGB and monochrome images have similar (not equal) field of view (FOV) and are captured at similar times, (4) the cameras are rigidly mounted to ensure that RGB and monochrome frames captured by these cameras stay in the same place relative to each other at all times, (5) different exposures are expected for RGB and mono cameras, but in practice could be very close, (6) synchronized capture between cameras at the same framerate, and the different control scenarios could be at different framerates (e.g., bright light 60 fps, low light 15 fps), (7) chroma information may be extracted from RGB and aligned and merged with mono luminosity, and (8) RGB-mono is a post processing algorithm applied on YUV4:2:0 and monochrome images.

FIG. 2A-2B illustrates an example RGB-mono fusion pipeline or algorithm for fusing color and monochrome images to generate a color passthrough image for an artificial reality system, in accordance with particular embodiments. Specifically, FIG. 2A illustrates an example mono-RGB fusion process or flow 200 for merging a monochrome image and a RGB image to generate a raw mono-RGB merged image (e.g., without any post processing). FIG. 2B illustrates an example de-noising process 250 to generate a de-noised mono-RGB merged image.

Referring to FIG. 2A, the RGB-mono fusion process 200 begins with a computing unit (e.g., computer unit 708 of the improved artificial reality system 700) receiving a monochrome image 202 and a color/RGB image 204. The computing unit may include at least one or more processors and memories that are configured to execute the mono-RGB fusion process 200 and the de-noising process 250 discussed herein. The monochrome image 202 may be captured by a monochrome camera 112a and the color image 204 may be captured by a RGB camera 110a. It should be noted that the fusion process 200 is described for a single side (e.g., left side 104) of the artificial system and the same process 200 may be repeated for the other side (e.g., right side 106) to generate a mono-RGB merged image for the other eye of the user. In particular embodiments, the monochrome image 202 and the color image 204 may be synchronously captured or may be captured at similar times.

Upon capturing or receiving the monochrome image 202 and the color image 204, captured images needs to be matched in both dynamic and geometric aspects since these images 202 and 204 are captured by different cameras with different locations. For dynamic range matching (also interchangeably herein referred to as tone matching or tone map matching 212), histogram statistics may be computed for each image. For instance, histogram statistics 206 may be computed for the monochrome image 202 and the histogram statistics 208 may be computed for the color image 204. The histogram statistics 206, 208 are gathered from the images 202, 204 to understand these images and various properties (e.g., luminance, autoexposure, etc.) associated with these images. Specifically, global histogram of mono and Y channel of RGB images are collected. For example, the histogram statistics 206 and 208 may indicate an overall brightness of images 202 and 204, respectively. The luminance and/or brightness information may be indicated through a histogram of pixel intensity values. For instance, the histogram is a graph showing the number of pixels in an image at each different intensity value found in that image.

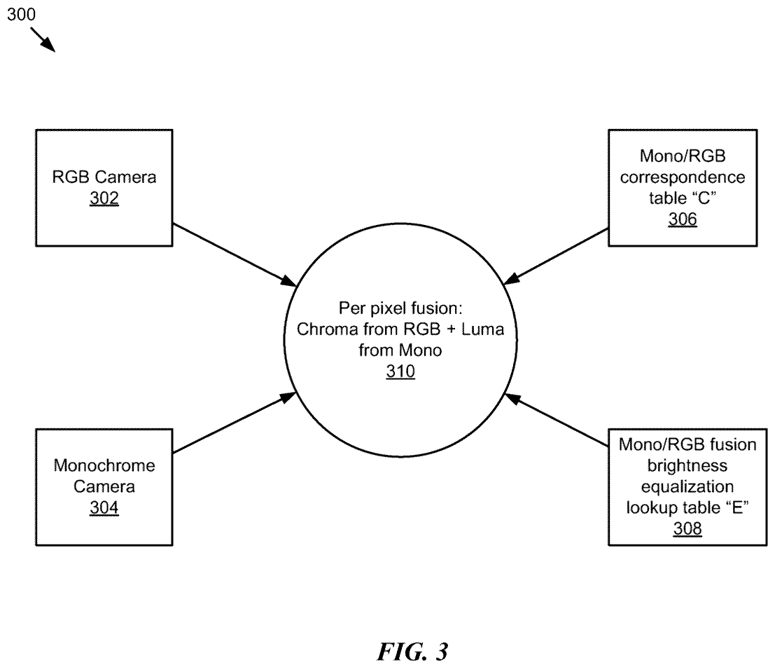

Responsive to computing the histogram statistics 206 and 208, tone mapping calculation 210 is performed to estimate a shift between the brightness and/or color of the monochrome image 202 and the color image 204. This shift may be estimated based on the histogram statistics computed for each image. Stated differently, based on the histogram statistics 206 and 208, an estimation of a difference in brightness and/or other levels between the two images 202 and 204 is calculated in the tone mapping calculation 210. By way of an example and without limitation, one image may have a luminance range of 0-100, whereas another image may have 80-200. If the shift or difference between the two images 202 and 204 is high, then the pixel intensity values in the monochrome image 202 needs to be normalized with respect to the color image 204. This normalization happens in the tone map matching 212, as discussed in further detail below. In some embodiments, the results of the tone mapping calculation 210 may be represented as a tabular format and the resulting table may be stored in a memory (e.g., memory 220) for later access and/or retrieval. For instance, the shifts in brightness and/or luminance values between the monochrome image 202 and the color/RGB image 204 may be represented in a brightness equalization table saved as table “E”. This table “E” may be used during the mono-RGB fusion process, as shown and discussed, for example, in reference to at least FIG. 3.

In the tone map matching 212 (also interchangeably referred to simply as tone matching or dynamic block matching), the monochrome image 202 is normalized with respect to the color image 204 based on the tone mapping calculation 210. This normalization is done to make sure that there is no significant or big shift between the two images 202 and 204 in terms of luminance and/or brightness and they better align with each other. For example, if one image is captured with a short exposure and the other image is captured with a long exposure, then one of the images needs to be normalized with respect to another to make sure that they look and align with each other. If tone map matching 212 is not performed, then the color of the fused image (e.g., mono-RGB merged image 226) may look inaccurate and weird. In some embodiments, the tone map matching 212 discussed herein may be performed based on features in the monochrome image 202 and the color image 204. For example, tone map matching 212 may be performed based on facial features identified in the images 202 and 204.

Upon performing the tone map matching 212, gaussian pyramid decomposition (GPD) may be performed for each of the images 202 and 204. Gaussian pyramid decomposition is a technique that breaks down an image into successively smaller groups of pixels to blur it. Stated differently, GPD transforms an image into a pyramid of images (or multiple levels of images) with varying resolutions at each level of the pyramid. For instance, GPD 214 transforms or breaks down the normalized monochrome image (after tone map matching 212) into a first pyramid of images and GPD 216 transforms or breaks down the color image 204 into a second pyramid of images. By way of an example and without limitation, GPD breaks down an image into 5 levels from low to high resolution, where pixels of images at the top level have the lowest resolution and pixels of images at the bottom most level has the highest resolution. The need for this gaussian pyramid decomposition is to accurately estimate motion between the monochrome and RGB images in the local motion estimation (LME) 222 block. Since the two images 202 and 204 are captured from different cameras and may be from different viewpoints, same objects in the two images may be at different distances and they shift differently. The confidence in finding the correspondence between two images for these objects may increase when comparing the pyramids (e.g., smaller groups of pixels or multiple levels) of the two images as compared to comparing the pixels of the two images as a whole. Therefore, higher the levels or groups of pixels of an image, higher are the chances of finding correspondence between the two images, because GPD reduces the fluctuations and finding the wrong matches.

In particular embodiments, the pyramids of images corresponding to the monochrome image and the color image that are obtained after the gaussian pyramid decomposition may be stored in a memory 220 for later access and/or retrieval, as indicated by reference numerals 215 and 217. For example, the first pyramid of images corresponding to the monochrome image 202 and the second pyramid of images corresponding to the color image 204 may be retrieved from the memory 220 to perform the local motion estimation 222, as discussed in further detail below. In particular embodiments, the memory 220 discussed herein may be a dynamic random access memory (DRAM) or a static random access memory (SRAM).

Next, the computing unit (e.g., computer unit 708 of the improved artificial reality system 700) performs the local motion estimation (LME) 222 based on the pyramid of images corresponding to the normalized monochrome image (e.g., obtained after tone map matching 212) and pyramid of images corresponding to the color image 204. The computing unit may retrieve these pyramids (e.g., mipmaps) from the memory 220 (indicated by reference numerals 219 and 221) to perform the LME 222. In particular embodiments, LME 222 may include performing FOV/geometric matching and calculating motion vectors. Since a monochrome camera (e.g., monochrome camera 112a) with which the monochrome image 202 is captured and a RGB camera (e.g., RGB camera 110a) with which the color image 204 is captured may include different optics (e.g., lens) or lens models, geometric matching needs to be performed in order to offset these different lens models. In some embodiments, geometric matching may include warping the images to offset the different lens models and bring the field of view associated with the pyramids of images (e.g., obtained after GPD 214 and 216) align with each other. Geometric matching may be performed statically or offline and may be part of a calibration process.

In particular embodiments, local motion estimation 222 may include calculating motion vectors (MVs) based on the pyramids of images corresponding to the tone matched monochrome and color/RGB images. Specifically, calculating the motion vectors include comparing the pyramids, different levels, or smaller groups of pixels of the tone matched monochrome and color/RGB images and finding the correspondence between pixels of the normalized monochrome image (e.g., obtained after tone map matching 212) and pixels of the RGB image 204. The result of the local motion estimation 222 is motion vectors, which may be represented as a matrix or grid-like structure indicating for each monochrome pixel, where it is located or reside within the RGB image. In other words, location correspondence between the monochrome image 202 and the color/RGB image 204 is represented by the motion vectors. These motion vectors may be stored in the memory 220 (indicated by reference numeral 223) and later be retrieved during the mono-RGB fusion, as discussed in further detail below with respect to the mono-RGB merge block 224.

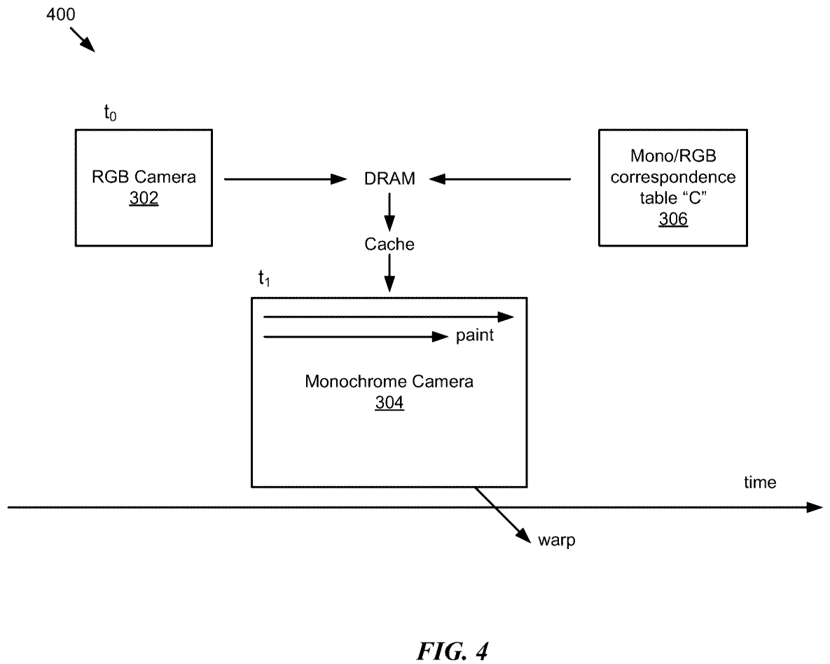

In particular embodiments, the motion vectors generated after the local motion estimation 222 may be represented in a tabular format and stored in the memory 220 for later access and/or retrieval. This tabular format may be stored as table “C” that stores correspondence information between the monochrome and RGB images discussed herein. Such table “C” may be used during the mono-RGB fusion process, as shown and discussed, for example, in reference to FIGS. 3 and 4.

In some embodiments, some of the monochrome pixels may not be matched with the RGB pixels. For instance, since the monochrome and color images 202, 204 are captured from different cameras with different viewpoints and with different optics, the objects in these images may be represented from different angles. Also, there may be some occlusions and flat areas (e.g., walls, ceilings, etc.) that hide some of the portions in the captured images. Due to this, some of the pixels in the pyramid of images corresponding to the monochrome image 202 may not be able to correspond or match with pixels in the pyramid of images corresponding to the color image 204. In such a scenario when the location correspondence for some pixels is not successful, alternative or fallback options may be adopted for these pixels. In one example embodiment, a confidence mapping table may be used to determine the confidence in mapping or location correspondence between pixels of the two images. For pixels with low confidence in mapping or location correspondence, grayscale pixels may be used instead and visually treated with silhouette. Also, depth information may be utilized to determine how far the objects are and then 1-1 correspondence may be used between the monochrome and RGB images. In case the objects are fairly apart, then it is assumed that there is zero shift between the monochrome and RGB images and color from the same coordinate of the monochrome pixel is used for that pixel where location correspondence was unsuccessful. Additionally, machine learning techniques may be utilized to colorize some portions of the monochrome image.

Next, the computing unit (e.g., computer unit 708 of the improved artificial reality system 700) performs the mono-RGB merge or fusion 224 based on the motion vectors obtained after the local motion estimation 222. The computing unit may retrieve these motion vectors from the memory 220 (indicated by reference numeral 225) to perform the mono-RGB merge 224. In particular embodiments, the mono-RGB merge 224 may include extracting color information from RGB pixels corresponding to the monochrome pixels using the motion vectors (e.g., location correspondence) and adding the extracted color information to the monochrome pixels. For instance, extracted color information may be added to Y channel extracted from the monochrome image. More specifically, the mono-RGB merge 224 may include using the luminance of a monochrome pixel and then copying the color information to the monochrome pixel from the corresponding pixel in the color/RGB image 204. The correspondence information between the monochrome and color/RGB pixels may be determined using the motion vectors, as discussed elsewhere herein. It should be noted that the mono-RGB merge 224 discussed herein is performed based on the pyramid of images corresponding to the monochrome image 202 and the pyramid of images corresponding to the color image 204. The computing unit may retrieve these pyramids of images from the memory 220, as indicated by reference numerals 228 and 230.

In particular embodiments, the mono-RGB merge 224 may output or generate a colorized high-resolution monochrome image or a mono-RGB merged image 226, which may be stored in the memory 220 (indicated by reference numeral 232) for later access and/or retrieval, such as, for example, to be used in the de-noising process 250 to generate a de-noised mono-RGB merged image, as discussed below in reference to FIG. 2B. In particular embodiments, the resulting mono-RGB merged image 226 that is output from the mono-RGB merge 224 may be a raw or unfiltered image containing some noise, such as luma and color noise. In order to improve the quality of stitched image and remove noise (e.g., luma and color noise, low frequency chroma noise), post processing treatments may be required. These treatments may include temporal noise reduction (TNR) and spatial noise reduction (SPR), which are now discussed in reference to FIG. 2B.

FIG. 2B illustrates an example de-noising process 250 to generate a de-noised mono-RGB merged image. In particular embodiments, the de-noising process 250 is performed to improve the quality of merged/stitched mono-RGB image 226 that is obtained in the RGB-mono fusion process 200 and to remove noise from the image, such as luma and color noise that may be coming from the cameras (e.g., RGB camera 110 or monochrome camera 112). In particular embodiments, the de-noising process 250 may begin right after the raw/unfiltered mono-RGB merged image 226 (e.g., without applying any post processing) is obtained after the mono-RGB merge 224 and stored in the memory 220. It should be noted that certain reference numerals that were used in FIG. 2A to refer to entities have been kept the same in FIG. 2B for ease of understanding and consistency. However, this is not by any way limiting and different reference numerals may be used to refer to these entities.

The de-noising process 250 begins with a computing unit (e.g., computer unit 708 of the improved artificial reality system 700) retrieving the mono-RGB merged image 226 that is obtained after the mono-RGB merge 224 for a current frame N from the memory 220, as indicated by reference numeral 251. In addition, a mono-RGB merged image 252 for a previous frame N-1 may also be retrieved from the memory 220, as indicated by reference numeral 251. Both the merged images 226 and 252 corresponding to current frame N and previous frame N-1, respectively, may be raw or unfiltered images without any post processing (e.g., denoising) applied.

Responsive to obtaining the raw/unfiltered merged images 226, 252 for the current frame N and previous frame N-1, local motion estimation 254 may be performed to calculate the motion vectors between the merged images generated for the current and previous frame. The motion vectors, as discussed elsewhere herein, may describe location correspondence between the current frame N and previous frames N-1. The motion vectors obtained after the local motion estimation 254 may provide temporal information, which is needed to perform the temporal noise reduction 256, as discussed below.

In particular embodiments, the temporal noise reduction (TNR) step 256 denoises the mono-RGB merged image 226 temporally using the temporal information obtained through the local motion estimation 254. To perform the TNR, certain data or information associated with the previous frame N-1 may be used to denoise the image 226. Data associated with the previous frame N-1 may be retrieved from the memory 220, as indicated by reference numeral 257. In certain embodiments, temporal denoise algorithm or approach may work in the fast DCT domain. The resulting image obtained after the TNR 256 (e.g., temporally de-noised mono-RGB merged image) may be stored in the memory 220 for later access and/or retrieval, as indicated by reference numeral 258.

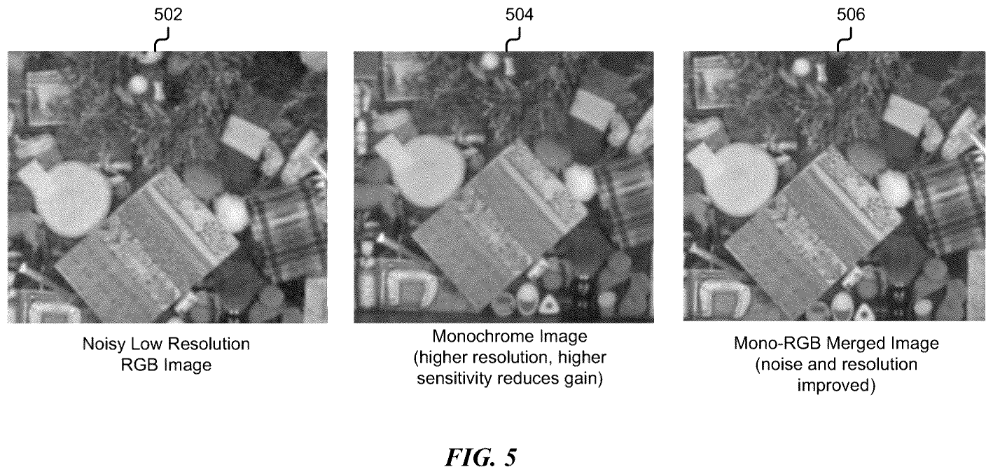

Next, the computing unit (e.g., computer unit 708 of the improved artificial reality system 700) perform spatial noise reduction (SNR) 260 to further de-noise the temporally de-noised mono-RGB image spatially. In order to perform the SNR 260, the computing unit may retrieve the temporally de-noised mono-RGB merged image from the memory 220, as indicated by reference numeral 259. In particular embodiments, the SNR algorithm or approach is based on a Non-Local Means approach. The resulting image obtained after the SNR 260 is now both a temporally and spatially de-noised image 262 with noise removed, as shown, for example, by image 506 in FIG. 5.

It should be noted that the post processing of the mono-RGB merged image 226 discussed herein is not limited to the de-noising process 250 illustrated in FIG. 2B and other variations and configurations of the de-noising process 250 are also possible and within the scope of the present disclosure. As an example, SNR 260 may be performed first followed by TNR 256. As another example, artificial intelligence (AI) based de-noising or more advance de-noising may be applied to the mono-RGB merged image 226. Other alternative post processing, filtering, and/or de-noising techniques are also possible and within the scope of the present disclosure.

FIG. 3 illustrates a high-level diagram 300 for fusion of monochrome and color images. In particular, the high-level diagram 300 shows main hardware and software components, at a high level, that may be needed for the fusion and how to implement the fusion. As depicted, data from different sources may be passed to a merging component to perform the merge or fusion of monochrome and color information. On the left side, the hardware elements or components required for the fusion includes an RGB/color camera 302 (or sensor comprised within the color camera 302) and a monochrome camera 304 (or sensor comprised within the monochrome camera 304). In one example implementation, the RGB camera 302 is a 4 MP camera and the monochrome camera 304 is a 16 MP camera. It should be noted that different resolutions or configurations of RGB and monochrome cameras are possible and within the scope of the present disclosure. For example, the RGB camera 302 and the monochrome camera 304 may both have a similar or same resolution. As another example, the RGB camera 302 may have a resolution considerably smaller than resolution of monochrome camera 304 since the human sensitivity to chroma is significantly lower than the human sensitivity to luma. Therefore, even with reduced resolution of RGB camera 302, the human eye may perceive a resulting image as good and may not notice any significant degradation in colors. In some embodiments, same or very close exposures may be used for high-resolution monochrome camera and 4× lower resolution RGB camera.

On the right side, two tables, including table “C” 306 and table “E” 308, are used for the fusion. Table “C” is a mono/RGB correspondence table that may be precomputed outside of image signal processing (ISP) on a digital signal processor (DSP) based on HMD, scene geometry, some DSP calculations, etc. In particular embodiments, the mono/RGB correspondence table “C” 306 may include motion vectors indicating location correspondence information between the monochrome and RGB images, as discussed above in reference to FIG. 2A. For instance, the table “C” may include for each monochrome pixel, where it is located or reside within the RGB image. Stated differently, table “C” 306 may include data defining how pixels of monochrome image corresponds to pixels of the RGB image. In particular embodiments, the mono/RGB correspondence table “C” contains correspondence data for 8×8 pixel grid. However, it should be understood that 8×8 is just an example and other pixel grids, including 4×4, 2×2, and 1×1 are also supported for foveal processing.

Table “E” 308 is a brightness equalization lookup table that may be precomputed outside on a DSP/central processing unit (CPU) based on current and previous image statistics. In particular embodiments, the mono/RGB fusion brightness equalization table “E” 308 may include shifts in brightness and/or luminance values between the monochrome and RGB images, as discussed above in reference to FIG. 2A. Using the table “E” 308, one or more of monochrome or RGB images may be normalized, as discussed, for example, with respect to tone map matching 212 in FIG. 2A.

The merging component (not shown), which may be a software component executable by the computing unit (e.g., computer unit 708 of the improved artificial reality system 700), may take as inputs at least: (1) a RGB image from the RGB camera 302, (2) a monochrome image from the monochrome camera 304, (3) mono/RGB correspondence data from table “C” 306, and (4) mono/RGB fusion brightness equalization data from table “E” 308, and perform per pixel fusion 310. Per pixel fusion 310 may include for each pixel of the monochrome image, extracting chroma from corresponding pixel in the RGB using the correspondence table “C” 306 and adding the extracted chrome to the luma from the monochrome image. In some embodiments, RGB-mono fusion could use a smooth vectors map defined by fixed point integer shifts (int, int) in 8×8 16 MP pixel cells. There may not be extra DRAM traffic in the 16 MP image if the fusion is part of image front end (IFE).

FIG. 4 illustrates another example data-flow diagram 400 for fusion of monochrome and color images. It should be noted that certain reference numerals that were used in FIG. 3 to refer to entities have been kept the same in FIG. 4 for ease of understanding, consistency, and to avoid repetition. At a high level, the data-flow diagram 400 illustrates a system memory architecture and timing aspects. The system discussed herein does not need to wait for a full frame to be processed at a particular time instance. If there is a slight offset in time, a first image may be quickly read at a first time to and while a second image is being read at time t₁, the first image may be processed and immediately merged with the image that was just captured (e.g., small resolution RGB image).

FIG. 5 illustrates an example comparison between an image 502 that is generated only with RGB cameras (e.g., RGB cameras 110), an image 504 that is generated only with monochrome cameras (e.g., monochrome cameras 112), and a mono-RGB merged image 506 that is generated based on the mono-RGB fusion process 200 and the de-noising process 250 discussed herein. As depicted, the image 502 that is generated only with the RGB cameras and associated sensor(s) is a noisy low-resolution RGB image. The image 502 contains color and/or low frequency chroma noise coming from the RGB cameras. Image 504 that is generated only with the monochrome cameras and associated sensor(s) is a high-resolution image but is not colored. Also, the higher sensitivity of the monochrome cameras reduce gain. The mono-RGB merged image 506 that is generated after the mono-RGB fusion process 200 and the de-noising process 250 (discussed in FIGS. 2A-2B) is a high-resolution color image with reduced/removed noise artifacts (e.g., color and luma noise, low frequency chroma noise).

In some embodiments, reconstructed three-dimensional (3D) meshes and hand tracking (HT) data at lower frequency may be used to allow additional information to resolve occlusions. The fusion algorithm or process 200 may use confidence of correlation between monochrome and color images and in case it is low (e.g., confidence is lower than a certain threshold), depth meshes may be used to re-project those blocks.

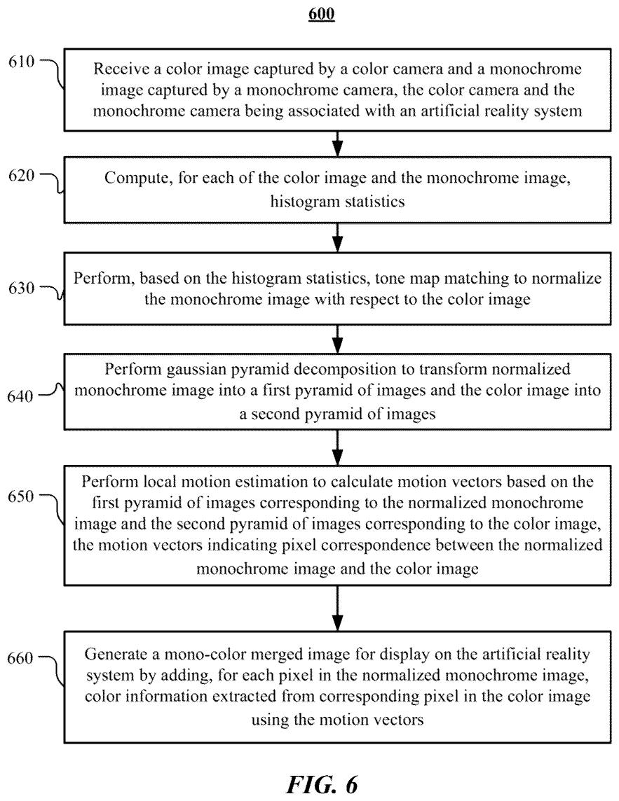

FIG. 6 illustrates an example method 600 for fusing a monochrome image and a color image to generate a mono-color merged image for display on an artificial reality system, in accordance with particular embodiments. In particular embodiments, the method 600 discussed herein may be performed in response to determining that lighting conditions associated with the artificial reality system fall within a certain luminance range. By way of an example and without limitation, the method 600 may be performed when the light level in which the artificial reality system is operating is low light, such as within 20-200 lux range, as discussed elsewhere herein. In particular embodiments, the artificial reality system discussed herein is a mixed reality headset.

The method 600 may begin at step 610, where a computing system (e.g., the computer 708) associated with an artificial reality system (e.g., the artificial reality system 700) may receive a color image captured by a color/RGB camera (e.g., using a sensor comprised within the color camera) and a monochrome image captured by a monochrome camera (e.g., using a sensor comprised within the monochrome camera). In particular embodiments, the color and monochrome images may be synchronously captured by the color and monochrome cameras, respectively, at similar times. The color camera and the monochrome camera may be associated with an artificial reality system. For instance, the color and monochrome cameras may be co-located near each or mounted next to each other on the artificial reality system, as shown, for example, in FIG. 1. In some embodiments, a resolution of the monochrome camera is higher than a resolution of the color camera. For example, the resolution of the monochrome camera is 16 MP, whereas the resolution of the color/RGB camera is 4 MP. In some embodiments, a resolution of each of the monochrome and color cameras is the same. For example, the resolution of both the monochrome and color cameras is 16 MP. In some embodiments, the same resolution of both the monochrome and color cameras may be binned. For example, the resolution of the color camera is 16 MP natively when in bright light (e.g., >200 lux) and the mono camera is not turned on. As another example, the resolution of the monochrome and color cameras may be 2:2 binned to 4 MP in low light conditions (e.g., light ranging in 20-200 lux) when the monochrome cameras are also used. Binning may also improve the low light sensitivity of the RGB camera.

At step 620, the computing system (e.g., the computer 708 of the artificial reality system 700) may compute, for each of the color image and the monochrome image, histogram statistics (e.g., histogram statistics 206 and 208). In particular embodiments, the histogram statistics may include one or more properties associated with color image and the monochrome image. For instance, the one or more properties may include brightness or luminance levels associated with each of the color image and the monochrome image, as discussed elsewhere herein.

At step 630, the computing system (e.g., the computer 708 of the artificial reality system 700) may perform, based on the histogram statistics, tone map matching (e.g., tone map matching 212) to normalize the monochrome image with respect to the color image. In particular embodiments, normalizing the monochrome image with respect to the color image may include adjusting the one or more properties (e.g., brightness and/or luminance levels) in the monochrome image to align with the one or more properties (e.g., brightness and/or luminance levels) of the color image.

At step 640, the computing system (e.g., the computer 708 of the artificial reality system 700) may perform gaussian pyramid decomposition (e.g., GPD 214 and 216) to transform normalized monochrome image into a first pyramid of images and the color image into a second pyramid of images. In particular embodiments, transforming the normalized monochrome image into the first pyramid of images and the color image into the second pyramid of images may include breaking each image into multiple levels of images with different resolutions or breaking each pixel of the image into a smaller group of pixels, as discussed, for example, with respect to GPD 214 and 216 in FIG. 2A.

At step 650, the computing system (e.g., the computer 708 of the artificial reality system 700) may perform local motion estimation (e.g., LME 222) to calculate motion vectors based on the first pyramid of images corresponding to the normalized monochrome image and the second pyramid of images corresponding to the color image. In particular embodiments, the motion vectors may indicate pixel correspondence (or location correspondence) between the normalized monochrome image and the color image. For instance, the motion vectors may be a matrix or grid-like structure indicating for each monochrome pixel, where it is located or reside within the RGB image.

At step 660, the computing system (e.g., the computer 708 of the artificial reality system 700) may generate a mono-color merged image (e.g., mono-RGB merged image 226) for display on the artificial reality system by adding, for each pixel in the normalized monochrome image, color information extracted from corresponding pixel in the color image using the motion vectors. Stated differently, color information is extracted from RGB pixels corresponding to the monochrome pixels using the motion vectors (e.g., location correspondence) and adding the extracted color information to the monochrome pixels. For instance, extracted color information may be added to Y channel extracted from the monochrome image.

In particular embodiments, the resulting mono-color merged image that is generated in step 660 may be a raw or unfiltered image containing some noise, such as luma and color noise coming from the monochrome and color cameras, respectively. In order to improve the quality of the merged image and remove noise (e.g., luma and color noise, low frequency chroma noise), post processing functions or treatments may be required. For instance, the computing system (e.g., the computer 708 of the artificial reality system 700) may be further configured to apply one or more post processing functions to the mono-color merged image (generated in step 660) to remove one or more noise artifacts (e.g., luma noise from the monochrome camera, color noise from the color camera, low frequency chroma noise from the color camera, etc.) from the mono-color merged image, generate a de-noised mono-color merged image based on applying the one or more post processing functions, and then displaying the de-noised mono-color merged image as a passthrough image on a display of the artificial reality system. In particular embodiments, the one or more post processing functions may include temporal noise reduction and spatial noise reduction, as discussed, for example, in reference to FIG. 2B.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for fusing a monochrome image and a color image to generate a mono-color merged image for display on an artificial reality system, including the particular steps of the method of FIG. 6, this disclosure contemplates any suitable method for fusing a monochrome image and a color image to generate a mono-color merged image for display on an artificial reality system, including any suitable steps, which may include a subset of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

FIG. 7 illustrates an example of an artificial reality system 700 (or artificial reality device 700) worn by a user 702. The artificial-reality system 700 may be used to implement some of the embodiments/examples disclosed herein. The artificial-reality system 700 may be configured to operate as a virtual reality display, an augmented reality display, and/or a mixed reality display. In particular embodiments, the artificial reality system 700 may comprise a head-mounted device (“HMD”) 704, a controller 706, and a computing system 708. The HMD 704 may be worn over the user's eyes and provide visual content to the user 702 through internal displays (not shown). The HMD 704 may have two separate internal displays, one for each eye of the user 702. As illustrated in FIG. 7, the HMD 704 may completely cover the user's field of view. By being the exclusive provider of visual information to the user 702, the HMD 704 achieves the goal of providing an immersive artificial-reality experience. In particular embodiments, the HMD 704 may be configured to present a view of the user's surrounding or external physical environment as one or more passthrough images (e.g., user 702 while wearing the HMD 704 may still be able to see the outside physical environment). As an example and without limitation, the image 506 may be provided as a passthrough image to the user 702.

The HMD 704 may have external-facing cameras (and/or sensors comprised within these cameras), such as the two forward-facing color cameras 701A and 701B, two forward-facing monochrome cameras 703A and 703B, and two tracking sensors 705A and 705B, as shown in FIG. 7. While only six cameras 701A-B, 703A-B, 705A-B are shown, the HMD 704 may have any number of cameras and/or sensors facing any direction. The external-facing cameras, including the color cameras 701A-B and monochrome cameras 703A-B, are configured to capture the physical environment around the user and may do so continuously to generate a sequence of frames (e.g., as a video). In particular embodiments, the color/RGB cameras 701A and 701B are configured to capture and generate color passthrough images. Each of the color cameras 701A and 701B may include one or more color sensors configured to captured incoming light and convert it into signals which result in a color image, such as color image 502. The monochrome cameras 703A and 703B are configured to capture and generate monochrome passthrough images. Each of the monochrome cameras 703A and 703B may include one or more monochrome sensors configured to captured incoming light at each pixel regardless of color and convert it into signals which result in a monochrome image, such as monochrome image 504. The tracking sensors 705A and 705B are configured to be used for tracking purposes, such as, for example, hand tracking, eye tracking, etc.

The 3D representation may be generated based on depth measurements of physical objects observed by the cameras 701A-B and/or 703A-B. Depth may be measured in a variety of ways. Although not shown, in some instances, the artificial reality system 700 may also include one or more depth sensors (e.g., time-of-flight (ToF) sensors or others) to measure depth measurements of physical objects observed by the cameras 701A-B and/or 703A-B. In particular embodiments, depth may be computed based on stereo images. For example, the two forward-facing cameras 701A-B may share an overlapping field of view and be configured to capture images simultaneously. As a result, the same physical object may be captured by both cameras 701A-B at the same time. For example, a particular feature of an object may appear at one pixel p_{A} in the image captured by camera 701A, and the same feature may appear at another pixel p_{B} in the image captured by camera 701B. As long as the depth measurement system knows that the two pixels correspond to the same feature, it could use triangulation techniques to compute the depth of the observed feature. For example, based on the camera 701A's position within a 3D space and the pixel location of p_{A} relative to the camera 701A's field of view, a line could be projected from the camera 701A and through the pixel P_{A}. A similar line could be projected from the other camera 701B and through the pixel p_{B}. Since both pixels are supposed to correspond to the same physical feature, the two lines should intersect. The two intersecting lines and an imaginary line drawn between the two cameras 701A and 701B form a triangle, which could be used to compute the distance of the observed feature from either camera 701A or 701B or a point in space where the observed feature is located.

In particular embodiments, the pose (e.g., position and orientation) of the HMD 704 within the environment may be needed. For example, in order to render the appropriate display for the user 702 while he is moving about in a virtual environment, the system 700 would need to determine his position and orientation at any moment. Based on the pose of the HMD, the system 700 may further determine the viewpoint of either of the cameras 701A-701B, 703A-703B, or either of the user's eyes. In particular embodiments, the HMD 704 may be equipped with inertial-measurement units (“IMU”). The data generated by the IMU, along with the stereo imagery captured by the external-facing cameras (e.g., 701A-B or 703A-B) and/or tracking sensors 705A-B, allow the system 700 to compute the pose of the HMD 704 using, for example, SLAM (simultaneous localization and mapping) or other suitable techniques.

In particular embodiments, the artificial reality system 700 may further have one or more controllers 706 that enable the user 702 to provide inputs. The controller 706 may communicate with the HMD 704 or a separate computing unit 708 via a wireless or wired connection. The controller 706 may have any number of buttons or other mechanical input mechanisms. In addition, the controller 706 may have an IMU so that the position of the controller 706 may be tracked. The controller 706 may further be tracked based on predetermined patterns on the controller. For example, the controller 706 may have several infrared LEDs or other known observable features that collectively form a predetermined pattern. Using a sensor or camera, the system 700 may be able to capture an image of the predetermined pattern on the controller. Based on the observed orientation of those patterns, the system may compute the controller's position and orientation relative to the sensor or camera.

The artificial reality system 700 may further include a computer unit 708. The computer unit 708 may be a stand-alone unit that is physically separate from the HMD 704 or it may be integrated with the HMD 704. In embodiments where the computer 708 is a separate unit, it may be communicatively coupled to the HMD 704 via a wireless or wired link. The computer 708 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 700 depends on the capabilities of its computer unit 708.

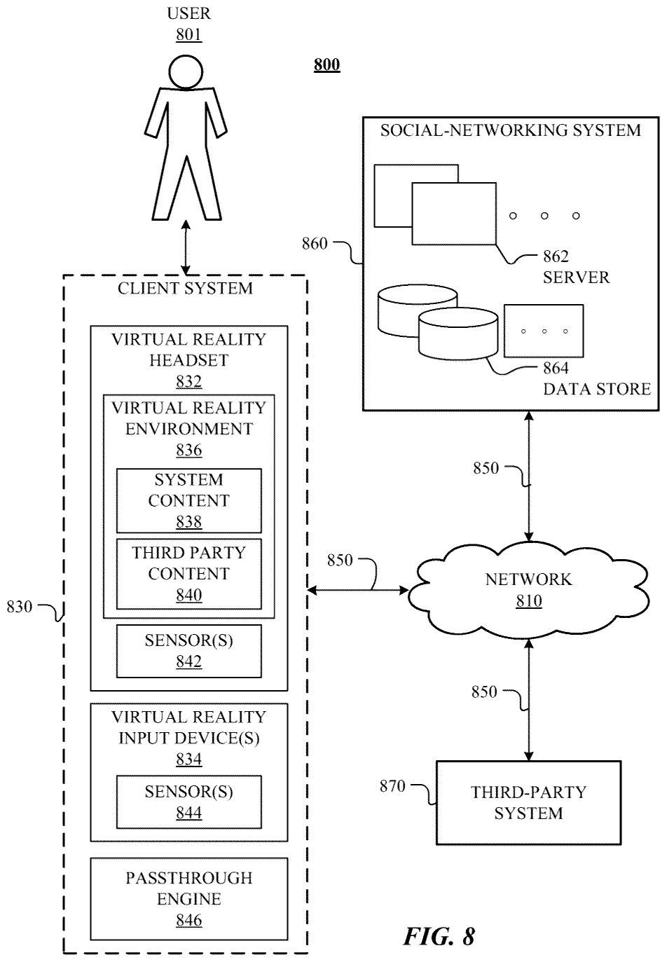

FIG. 8 illustrates an example network environment 800 associated with an artificial reality system. Although FIG. 8 may be illustrated with a virtual reality system, this example network environment 800 may include one or more other artificial reality systems, such as mixed reality systems, augmented reality systems, etc. Network environment 800 includes a user 801 interacting with a client system 830, a social-networking system 860, and a third-party system 870 connected to each other by a network 810. Although FIG. 8 illustrates a particular arrangement of a user 801, a client system 830, a social-networking system 860, a third-party system 870, and a network 810, this disclosure contemplates any suitable arrangement of a user 801, a client system 830, a social-networking system 860, a third-party system 870, and a network 810. As an example and not by way of limitation, two or more of a user 801, a client system 830, a social-networking system 860, and a third-party system 870 may be connected to each other directly, bypassing a network 810. As another example, two or more of a client system 830, a social-networking system 860, and a third-party system 870 may be physically or logically co-located with each other in whole or in part. Moreover, although FIG. 8 illustrates a particular number of users 801, client systems 830, social-networking systems 860, third-party systems 870, and networks 810, this disclosure contemplates any suitable number of client systems 830, social-networking systems 860, third-party systems 870, and networks 810. As an example and not by way of limitation, network environment 800 may include multiple users 801, client systems 830, social-networking systems 860, third-party systems 870, and networks 810.

This disclosure contemplates any suitable network 810. As an example and not by way of limitation, one or more portions of a network 810 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 810 may include one or more networks 810.

Links 850 may connect a client system 830, a social-networking system 860, and a third-party system 870 to a communication network 810 or to each other. This disclosure contemplates any suitable links 850. In particular embodiments, one or more links 850 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 850 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 850, or a combination of two or more such links 850. Links 850 need not necessarily be the same throughout a network environment 800. One or more first links 850 may differ in one or more respects from one or more second links 850.

In particular embodiments, a client system 830 may be an electronic device including hardware, software, or embedded logic components or a combination of two or more such components and capable of carrying out the appropriate functionalities implemented or supported by a client system 830. As an example and not by way of limitation, a client system 830 may include a computer system such as a desktop computer, notebook or laptop computer, netbook, a tablet computer, e-book reader, GPS device, camera, personal digital assistant (PDA), handheld electronic device, cellular telephone, smartphone, virtual reality or mixed reality headset and controllers, other suitable electronic device, or any suitable combination thereof. This disclosure contemplates any suitable client systems 830. A client system 830 may enable a network user at a client system 830 to access a network 810. A client system 830 may enable its user to communicate with other users at other client systems 830. A client system 830 may generate a virtual reality environment or a mixed reality environment for a user to interact with content.

In particular embodiments, a client system 830 may include a virtual reality (or augmented reality or mixed reality) headset 832, and virtual reality input device(s) 834, such as a virtual reality controller. A user at a client system 830 may wear the virtual reality headset 832 and use the virtual reality input device(s) to interact with a virtual reality environment 836 generated by the virtual reality headset 832. Although not shown, a client system 830 may also include a separate processing computer and/or any other component of a virtual reality system. A virtual reality headset 832 may generate a virtual reality environment 836, which may include system content 838 (including but not limited to the operating system), such as software or firmware updates and also include third-party content 840, such as content from applications or dynamically downloaded from the Internet (e.g., web page content). A virtual reality headset 832 may include sensor(s) 842, such as accelerometers, gyroscopes, magnetometers to generate sensor data that tracks the location of the headset device 832. The headset 832 may also include eye trackers for tracking the position of the user's eyes or their viewing directions. The client system may use data from the sensor(s) 842 to determine velocity, orientation, and gravitation forces with respect to the headset. Virtual reality input device(s) 834 may include sensor(s) 844, such as accelerometers, gyroscopes, magnetometers, and touch sensors to generate sensor data that tracks the location of the input device 834 and the positions of the user's fingers. The client system 830 may make use of outside-in tracking, in which a tracking camera (not shown) is placed external to the virtual reality headset 832 and within the line of sight of the virtual reality headset 832. In outside-in tracking, the tracking camera may track the location of the virtual reality headset 832 (e.g., by tracking one or more infrared LED markers on the virtual reality headset 832). Alternatively or additionally, the client system 830 may make use of inside-out tracking, in which a tracking camera (not shown) may be placed on or within the virtual reality headset 832 itself. In inside-out tracking, the tracking camera may capture images around it in the real world and may use the changing perspectives of the real world to determine its own position in space.

In particular embodiments, client system 830 (e.g., an HMD) may include a passthrough engine 846 to provide the passthrough feature described herein, and may have one or more add-ons, plug-ins, or other extensions. A user at client system 830 may connect to a particular server (such as server 862, or a server associated with a third-party system 870). The server may accept the request and communicate with the client system 830.

Third-party content 840 may include a web browser and may have one or more add-ons, plug-ins, or other extensions. A user at a client system 830 may enter a Uniform Resource Locator (URL) or other address directing a web browser to a particular server (such as server 862, or a server associated with a third-party system 870), and the web browser may generate a Hyper Text Transfer Protocol (HTTP) request and communicate the HTTP request to server. The server may accept the HTTP request and communicate to a client system 830 one or more Hyper Text Markup Language (HTML) files responsive to the HTTP request. The client system 830 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation combinations of markup language and scripts, and the like. Herein, reference to a web interface encompasses one or more corresponding source files (which a browser may use to render the web interface) and vice versa, where appropriate.

In particular embodiments, the social-networking system 860 may be a network-addressable computing system that can host an online social network. The social-networking system 860 may generate, store, receive, and send social-networking data, such as, for example, user-profile data, concept-profile data, social-graph information, or other suitable data related to the online social network. The social-networking system 860 may be accessed by the other components of network environment 800 either directly or via a network 810. As an example and not by way of limitation, a client system 830 may access the social-networking system 860 using a web browser of a third-party content 840, or a native application associated with the social-networking system 860 (e.g., a mobile social-networking application, a messaging application, another suitable application, or any combination thereof) either directly or via a network 810. In particular embodiments, the social-networking system 860 may include one or more servers 862. Each server 862 may be a unitary server or a distributed server spanning multiple computers or multiple datacenters. Servers 862 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 862 may include hardware, software, or embedded logic components or a combination of two or more such components for carrying out the appropriate functionalities implemented or supported by server 862. In particular embodiments, the social-networking system 860 may include one or more data stores 864. Data stores 864 may be used to store various types of information. In particular embodiments, the information stored in data stores 864 may be organized according to specific data structures. In particular embodiments, each data store 864 may be a relational, columnar, correlation, or other suitable database. Although this disclosure describes or illustrates particular types of databases, this disclosure contemplates any suitable types of databases. Particular embodiments may provide interfaces that enable a client system 830, a social-networking system 860, or a third-party system 870 to manage, retrieve, modify, add, or delete, the information stored in data store 864.

In particular embodiments, the social-networking system 860 may store one or more social graphs in one or more data stores 864. In particular embodiments, a social graph may include multiple nodes—which may include multiple user nodes (each corresponding to a particular user) or multiple concept nodes (each corresponding to a particular concept)—and multiple edges connecting the nodes. The social-networking system 860 may provide users of the online social network the ability to communicate and interact with other users. In particular embodiments, users may join the online social network via the social-networking system 860 and then add connections (e.g., relationships) to a number of other users of the social-networking system 860 whom they want to be connected to. Herein, the term “friend” may refer to any other user of the social-networking system 860 with whom a user has formed a connection, association, or relationship via the social-networking system 860.

In particular embodiments, the social-networking system 860 may provide users with the ability to take actions on various types of items or objects, supported by the social-networking system 860. As an example and not by way of limitation, the items and objects may include groups or social networks to which users of the social-networking system 860 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 860 or by an external system of a third-party system 870, which is separate from the social-networking system 860 and coupled to the social-networking system 860 via a network 810.

In particular embodiments, the social-networking system 860 may be capable of linking a variety of entities. As an example and not by way of limitation, the social-networking system 860 may enable users to interact with each other as well as receive content from third-party systems 870 or other entities, or to allow users to interact with these entities through an application programming interfaces (API) or other communication channels.

In particular embodiments, a third-party system 870 may include one or more types of servers, one or more data stores, one or more interfaces, including but not limited to APIs, one or more web services, one or more content sources, one or more networks, or any other suitable components, e.g., that servers may communicate with. A third-party system 870 may be operated by a different entity from an entity operating the social-networking system 860. In particular embodiments, however, the social-networking system 860 and third-party systems 870 may operate in conjunction with each other to provide social-networking services to users of the social-networking system 860 or third-party systems 870. In this sense, the social-networking system 860 may provide a platform, or backbone, which other systems, such as third-party systems 870, may use to provide social-networking services and functionality to users across the Internet.

In particular embodiments, a third-party system 870 may include a third-party content object provider. A third-party content object provider may include one or more sources of content objects, which may be communicated to a client system 830. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 860 also includes user-generated content objects, which may enhance a user's interactions with the social-networking system 860. User-generated content may include anything a user can add, upload, send, or “post” to the social-networking system 860. As an example and not by way of limitation, a user communicates posts to the social-networking system 860 from a client system 830. Posts may include data such as status updates or other textual data, location information, photos, videos, links, music or other similar data or media. Content may also be added to the social-networking system 760 by a third-party through a “communication channel,” such as a newsfeed or stream.

In particular embodiments, the social-networking system 860 may include a variety of servers, sub-systems, programs, modules, logs, and data stores. In particular embodiments, the social-networking system 860 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 860 may also include suitable components such as network interfaces, security mechanisms, load balancers, failover servers, management-and-network-operations consoles, other suitable components, or any suitable combination thereof. In particular embodiments, the social-networking system 860 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 860 to one or more client systems 830 or one or more third-party systems 870 via a network 810. The web server may include a mail server or other messaging functionality for receiving and routing messages between the social-networking system 860 and one or more client systems 830. An API-request server may allow a third-party system 870 to access information from the social-networking system 860 by calling one or more APIs. An action logger may be used to receive communications from a web server about a user's actions on or off the social-networking system 860. In conjunction with the action log, a third-party-content-object log may be maintained of user exposures to third-party-content objects. A notification controller may provide information regarding content objects to a client system 830. Information may be pushed to a client system 830 as notifications, or information may be pulled from a client system 830 responsive to a request received from a client system 830. Authorization servers may be used to enforce one or more privacy settings of the users of the social-networking system 860. A privacy setting of a user determines how particular information associated with a user can be shared. The authorization server may allow users to opt in to or opt out of having their actions logged by the social-networking system 860 or shared with other systems (e.g., a third-party system 870), such as, for example, by setting appropriate privacy settings. Third-party-content-object stores may be used to store content objects received from third parties, such as a third-party system 870. Location stores may be used for storing location information received from client systems 830 associated with users. Advertisement-pricing modules may combine social information, the current time, location information, or other suitable information to provide relevant advertisements, in the form of notifications, to a user.

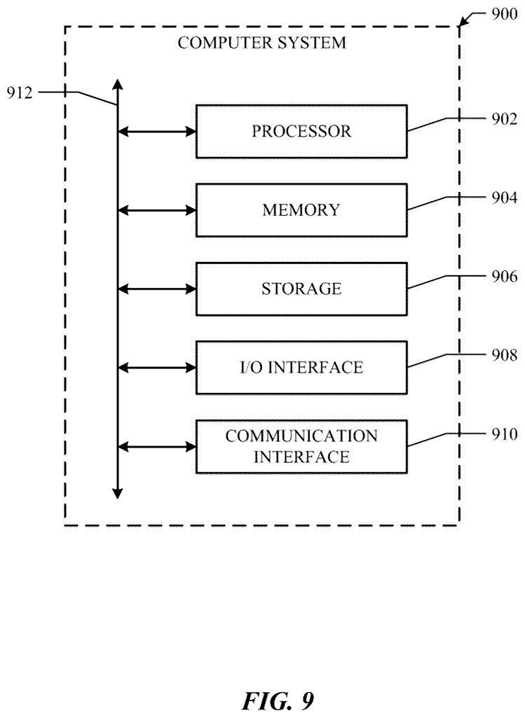

FIG. 9 illustrates an example computer system 900. In particular embodiments, one or more computer systems 900 perform one or more steps of one or more processes, algorithms, techniques, or methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
receiving a color image captured by a color camera and a monochrome image captured by a monochrome camera, wherein the color camera and the monochrome camera are associated with an artificial reality system;
computing, for each of the color image and the monochrome image, histogram statistics;
performing, based on the histogram statistics, tone map matching to normalize the monochrome image with respect to the color image;
performing gaussian pyramid decomposition to transform normalized monochrome image into a first pyramid of images and the color image into a second pyramid of images;
performing local motion estimation to calculate motion vectors based on the first pyramid of images corresponding to the normalized monochrome image and the second pyramid of images corresponding to the color image, wherein the motion vectors indicate pixel correspondence between the normalized monochrome image and the color image; and
generating a mono-color merged image for display on the artificial reality system by adding, for each pixel in the normalized monochrome image, color information extracted from corresponding pixel in the color image using the motion vectors.

2. The method of claim 1, further comprising:
applying one or more post processing functions to the mono-color merged image to remove one or more noise artifacts from the mono-color merged image; and
generating a de-noised mono-color merged image based on applying the one or more post processing functions.

3. The method of claim 2, wherein the one or more post processing functions comprise:
temporal noise reduction; and
spatial noise reduction.

4. The method of claim 2, wherein the one or more noise artifacts comprise:
luma noise from the monochrome camera;
color noise from the color camera; or
low frequency chroma noise from the color camera.

5. The method of claim 2, further comprising:
displaying the de-noised mono-color merged image as a passthrough image on a display of the artificial reality system.

6. The method of claim 1, further comprising:
determining that lighting conditions associated with the artificial reality system fall within a certain luminance range; and
performing a mono-color fusion process to generate the mono-color merged image responsive to determining that the lighting conditions associated with the artificial reality system fall within the certain luminance range.

7. The method of claim 1, wherein the histogram statistics comprise one or more properties associated with color image and the monochrome image.

8. The method of claim 7, wherein the one or more properties comprise brightness or luminance levels.

9. The method of claim 7, wherein normalizing the monochrome image with respect to the color image comprises:
adjusting the one or more properties in the monochrome image to align with the one or more properties of the color image.

10. The method of claim 1, wherein a resolution of the monochrome camera is higher than a resolution of the color camera.

11. The method of claim 1, wherein a resolution of each of the monochrome and color cameras is the same.

12. The method of claim 1, wherein color and monochrome cameras are mounted next to each other on a head-mounted device (HMD) of the artificial reality system.

13. The method of claim 1, wherein the color image and the monochrome image are synchronously captured at similar times.

14. The method of claim 1, wherein the artificial reality system is a mixed reality headset.

15. One or more computer-readable non-transitory storage media embodying software that is operable when executed to:
receive a color image captured by a color camera and a monochrome image captured by a monochrome camera, wherein the color camera and the monochrome camera are associated with an artificial reality system;
compute, for each of the color image and the monochrome image, histogram statistics;
perform, based on the histogram statistics, tone map matching to normalize the monochrome image with respect to the color image;
perform gaussian pyramid decomposition to transform normalized monochrome image into a first pyramid of images and the color image into a second pyramid of images;
perform local motion estimation to calculate motion vectors based on the first pyramid of images corresponding to the normalized monochrome image and the second pyramid of images corresponding to the color image, wherein the motion vectors indicate pixel correspondence between the normalized monochrome image and the color image; and
generate a mono-color merged image for display on the artificial reality system by adding, for each pixel in the normalized monochrome image, color information extracted from corresponding pixel in the color image using the motion vectors.

16. The media of claim 15, wherein the software is further operable when executed to:
apply one or more post processing functions to the mono-color merged image to remove one or more noise artifacts from the mono-color merged image; and
generate a de-noised mono-color merged image based on applying the one or more post processing functions.

17. The media of claim 16, wherein the one or more post processing functions comprise:
temporal noise reduction; and
spatial noise reduction.

18. An artificial reality device comprising:
at least one color camera;
at least one monochrome camera;
at least one display component;
one or more processors; and
one or more computer-readable non-transitory storage media coupled to one or more of the processors and comprising instructions operable when executed by one or more of the processors to cause the artificial reality device to:
receive a color image captured by the color camera and a monochrome image captured by the monochrome camera;
compute, for each of the color image and the monochrome image, histogram statistics;
perform, based on the histogram statistics, tone map matching to normalize the monochrome image with respect to the color image;
perform gaussian pyramid decomposition to transform normalized monochrome image into a first pyramid of images and the color image into a second pyramid of images;
perform local motion estimation to calculate motion vectors based on the first pyramid of images corresponding to the normalized monochrome image and the second pyramid of images corresponding to the color image, wherein the motion vectors indicate pixel correspondence between the normalized monochrome image and the color image; and
generate a mono-color merged image for display on the display component by adding, for each pixel in the normalized monochrome image, color information extracted from corresponding pixel in the color image using the motion vectors.

19. The artificial reality device of claim 18, wherein the one or more processors are further operable when executing the instructions to cause the artificial reality device to:
apply one or more post processing functions to the mono-color merged image to remove one or more noise artifacts from the mono-color merged image; and
generate a de-noised mono-color merged image based on applying the one or more post processing functions.

20. The artificial reality device of claim 19, wherein the one or more post processing functions comprise:
temporal noise reduction; and
spatial noise reduction.
